(19) United States
(12) Patent Application Publication
(10) Pub. No.: US 2017/0101795 A1
(43) Pub. Date: Apr. 13, 2017

(54) POOL SKIMMER PROTECTOR

(71) Applicant: Matthew Coughlin, Broadview Heights, OH (US)

(72) Inventor: Matthew Coughlin, Broadview Heights, OH (US)

(21) Appl. No.: 15/202,135

(22) Filed: Jul. 5, 2016

Related U.S. Application Data
(60) Provisional application No. 62/240,771, filed on Oct. 13, 2015.

(51) Int. Cl. E04H 4/12; F16L 55/11

(52) U.S. Cl. CPC E04H 4/1272; F16L 55/11

(57) ABSTRACT

A winterizing skimmer protector for a pool skimmer including a plug insert dimensioned to occupy a majority of the interior space of the pool skimmer. The plug insert further includes a rear aperture for receiving an anchoring pin.

This application claims priority to U.S. Provisional Patent Application No. 62/240,771, filed Oct. 13, 2015, by Matthew Coughlin and entitled “POOL SKIMMER PROTECTOR”; and is incorporated herein by reference in its entirety.

### BACKGROUND

Swimming pools generally have a port opening formed in the upper portion on one side wall and to which a swimming pool skimmer structure is mounted in sealed registration therewith so that pool water can flow from the swimming pool through the port opening and then into the pool skimmer structure. The pool skimmer structure is a container-like structure and has at least one conduit extending from it for connection to the filtration equipment so that pool water can be continuously directed from the pool skimmer structure into and through the filtration equipment whereupon the filtered pool water is returned to the swimming pool by a return conduit that is in sealed registration with a pool water return port opening formed on the side wall at some distance from the skimmer opening. Depending on the type of swimming pool design, the pool skimmer structure can either be mounted directly to the external surface of the pool side wall; or the pool skimmer structure can include a throat portion that partially projects through the upper port opening of the pool side wall and sealably attaches to the interior surface of the side wall by a lip or flange that surrounds the upper port opening. However, the pool skimmer structure is permanently secured to the pool side wall, and thus cannot be removed for swimming pool maintenance, upkeep or the yearly swimming pool opening and closing procedures.

When closing a pool for the winter, it is important to empty the pool skimmer to prevent damage due to freezing. One method of emptying the skimmer is by draining the pool until the water level is below the lower edge of the skimmer mouth or opening. Another technique is to cover the opening into the pool skimmer, thereby preventing the entry of water, and then draining any remaining water from the skimmer line. When a cover is used, it must be leak-proof over a broad range of ambient temperatures in order to be effective.

When performing pool maintenance, the port opening connecting the swimming pool to the pool skimmer structure must be closed off or blocked to minimize or prevent the loss of pool water. In addition, in cold climates, when closing down the swimming pool, the port opening must be closed or blocked to prevent pool water from flowing into the filtration equipment and damaging the filtration equipment when the pool water freezes and expands.

Some prior known cover assemblies for pool skimmers require a specific type of face plate to be installed over the skimmer opening. A cover is then removably mounted over the peripheral edge of the face plate. It would be useful to develop a skimmer protector which prohibits frozen water damage of the skimmer and does not require use of a specific type of face plate, and/or particular mounting hardware, at the skimmer opening.

It is an object of the present invention to provide a novel skimmer protector or plug assembly that will prevent ice damage to the skimmer and avoid requiring the water level of the pool to be reduced when the pool is winterized; and/or provide protection to the skimmer if the water level rises above the skimmer mouth during periods of non-use when the temperature may fall below freezing. Water levels can rise if a pool cover allows rain water or melting snow to pass therethrough. The rising water level can go undetected when the water level is obscured by the pool cover.

A further object is to provide such a skimmer protector that can be installed and removed quickly and easily without the use of tools.

Another object is to provide a skimmer protector or plug assembly which can be used on skimmers that do not have face plates.

A further object is to provide a skimmer protector which can be adapted for some variation in the dimensioning of the flow passage.

A variety of swimming pool sealing and closure assemblies and systems have been developed to close off the opening between the swimming pool and the pool skimmer structure. For example, Simonelli (U.S. Pat. No. 4,281,422) discloses a winterizing kit that includes a socket plug that fits into a female receptacle of a filtered water inlet. However, the socket plug includes a check valve and nipple to impede the flow of water from the swimming pool and also to disconnect the air compressor attached to the pool water line.

Weir (U.S. Pat. No. 4,825,605) discloses a closure device for pre-formed wall openings in swimming pool side wall panels that includes the insertion of either rectangular or circular-shaped plugs into the wall openings. However, since the plugs are used to close unwanted openings in the wall of the swimming pool, the plugs are fixedly secured to the side wall of the pool.

Dengel et al. (U.S. Pat. No. 4,903,351) discloses a winterizing faceplate kit for the side wall of a swimming pool. The kit includes a cover plate, a face plate, and a pair of gaskets. The cover plate being the element adapted for removable securement to the side wall to facilitate the ‘spring season’ opening and the ‘fall season’ closure of the swimming pool.

Hodak (U.S. Pat. No. 4,913,810) discloses a skimmer apparatus sealing and closure assembly similar to Dengel's kit and which includes a gasket frame, a faceplate, and a cover panel all attachable to the inside surface of the pool wall for closing off the water flow from the swimming pool to the skimmer apparatus.

Hodak (U.S. Pat. No. 5,285,538) discloses a sealing assembly similar in structure and function to Dengel and Hodak's assemblies and which includes a face plate and a flexible cover element securable to the inside surface of the swimming pool side wall. However, the cover plates of Dengal and Hodak may be not durable over an extended period of time.

Therefore, what is needed is a blocking or closure assembly that is durable, easy to install, and provides a barrier or water block between the swimming pool and the pool skimmer apparatus.

### BRIEF DESCRIPTION

The present invention is for use in conjunction with a swimming pool skimmer 10 and, more particularly, includes a skimmer protector or plug assembly 12 for selectively blocking off the swimming pool water from the skimmer 10 during periods of maintenance and non-use or winterizing.

The skimmer protector or plug assembly 12 can include an insert 14 and an anchoring pin 16 for removable retention within the skimmer 10. The insert 14 can have a configuration generally co-extensive with the walls 22, 24, 26, 28 of the housing of the skimmer 10 in order to completely consume or occupy the area, or at least significantly occupy the area, forming the opening or mouth 30, and remaining interior, of the swimming pool skimmer 10. The skimmer insert 14 can include an aperture 40 proximal to a rear section or portion 20 of the insert 14. The aperture 40 can receive the anchoring pin 16 for centering and positioning the skimmer plug assembly 12, as well as, prohibiting movement of the insert 14 within the pool skimmer 10. Both the insert 14 and the anchoring pin 16 are secured generally by frictional forces (i.e. without the use of hardware).

The pool skimmer insert 14 proximal to a front section or portion 18, can include a rectilinear face portion 50 generally conforming to the dimensions of the skimmer mouth or skimmer opening 30 in the pool wall 52. The skimmer insert 14 and anchoring pin 16 can be comprised of a volume such that the combined elements provide a plug assembly 12 occupying a majority of the volume of space within the pool skimmer 10. In this manner, a majority of the water that could be retained in the pool skimmer 10 is displaced upon insertion of the skimmer insert 14 and anchoring pin 16.

It is an objective of the present invention to provide a skimmer plug assembly 12 that is durable, lightweight, and easy to insert and remove from the pool skimmer 10.

It is another objective of the present invention to provide a skimmer plug assembly 12 that can effectively displace nearly all of the water in the area comprising the mouth 30 of the skimmer 10, and also displace the water in the throat opening 30 of the pool skimmer 10. In this manner, the plug assembly 12 occupies a majority of the area or space comprising the interior of the pool skimmer 10.

Yet another objective of the present invention is to provide a skimmer plug assembly 12 that can be used with swimming pool skimmers incorporating a variety of different designs and configurations.

### BRIEF DESCRIPTION OF THE DRAWINGS

FIG. 1 is a front perspective view of a skimmer insert or plug assembly;

FIG. 2 is a rear perspective view of the skimmer insert;

FIG. 3 is a top elevational view of the skimmer insert;

FIG. 4 is a side elevational view of the skimmer insert;

FIG. 5 is a perspective view of an anchoring pin;

FIG. 6 is a top elevational view of the anchoring pin;

FIG. 7 is a cross-sectional view of the anchoring pin taken along line 7-7 of FIG. 6;

FIG. 8 is a perspective view of a pool skimmer sans the skimmer insert;

FIG. 9 is a perspective view of the pool skimmer partially displaying the skimmer insert and anchoring pin;

FIG. 10 is a top view partially in section of the pool skimmer sans the skimmer insert;

FIG. 11 is a top view partially in section of the pool skimmer and skimmer insert and anchoring pin mounted therein; and,

FIG. 12 is a cross-sectional view, taken along line 12-12 of FIG. 11, of the pool skimmer and skimmer insert along with the anchoring pin mounted therein.

### DETAILED DESCRIPTION

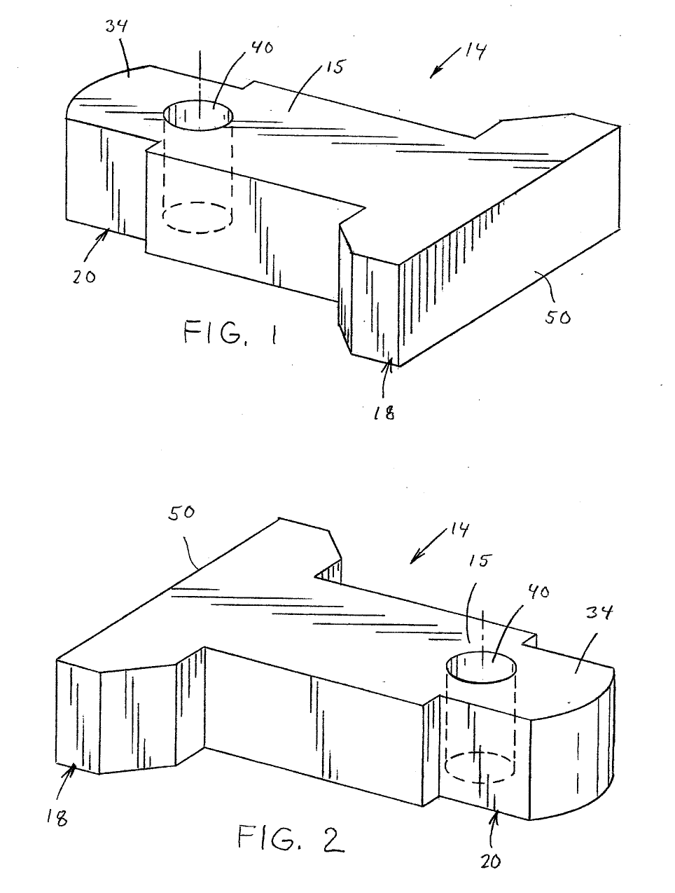

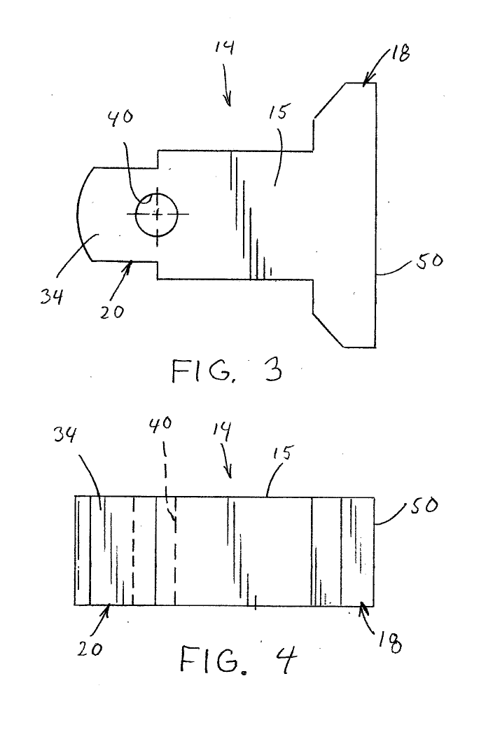

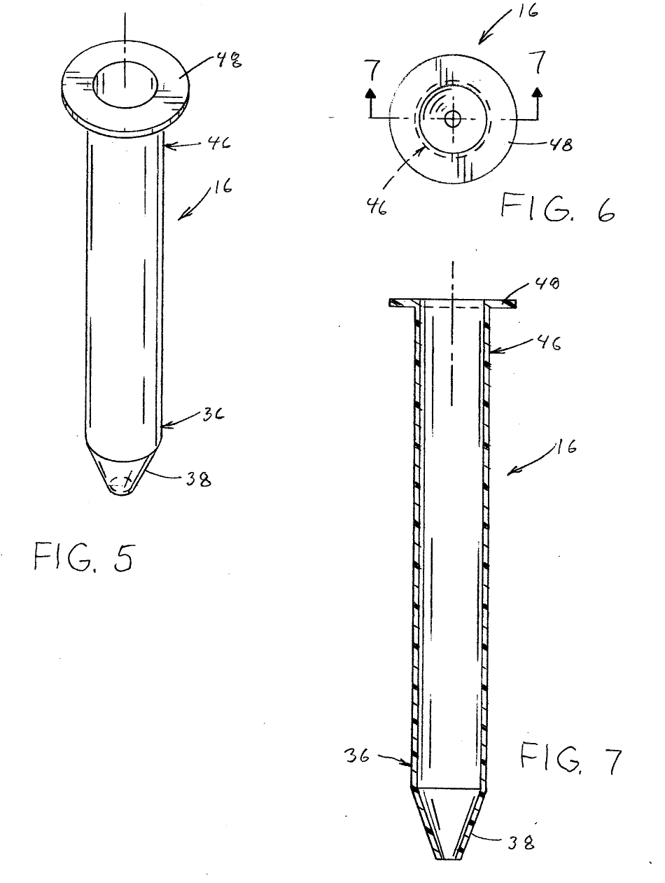

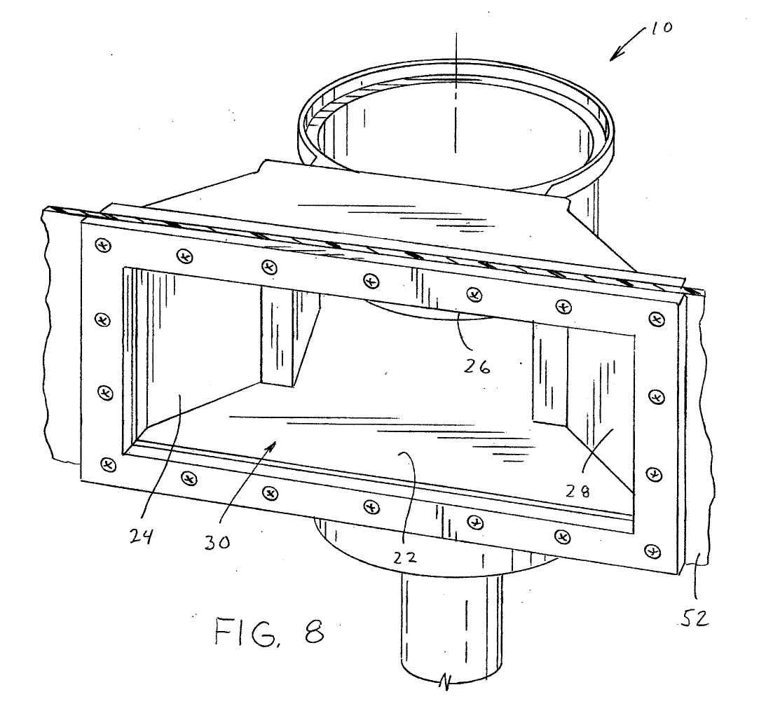

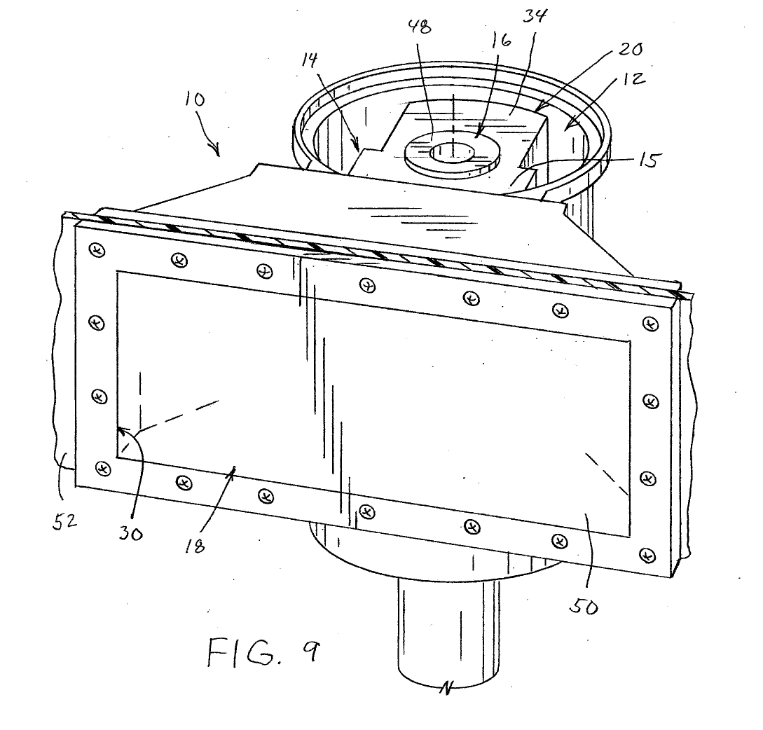

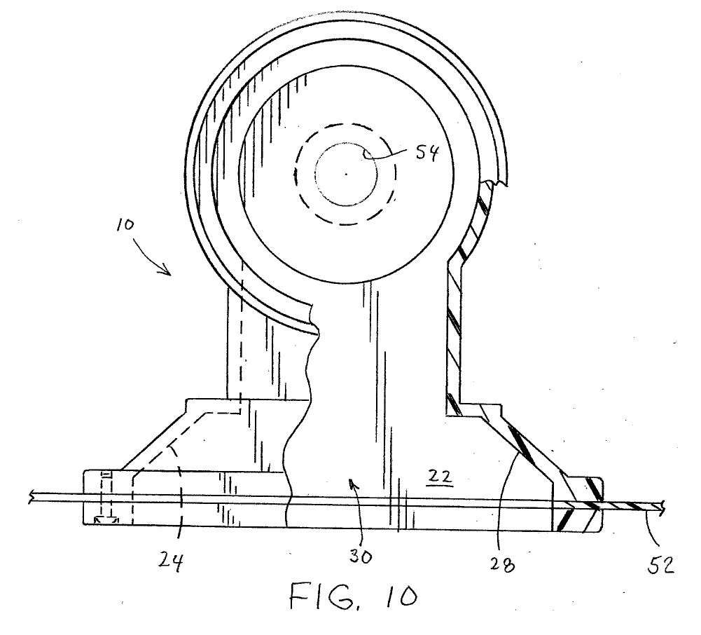

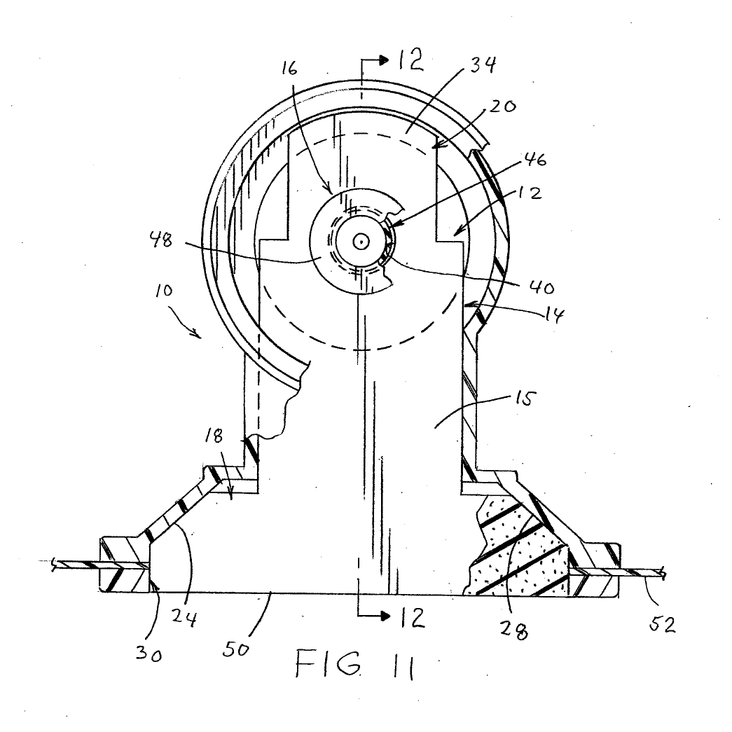

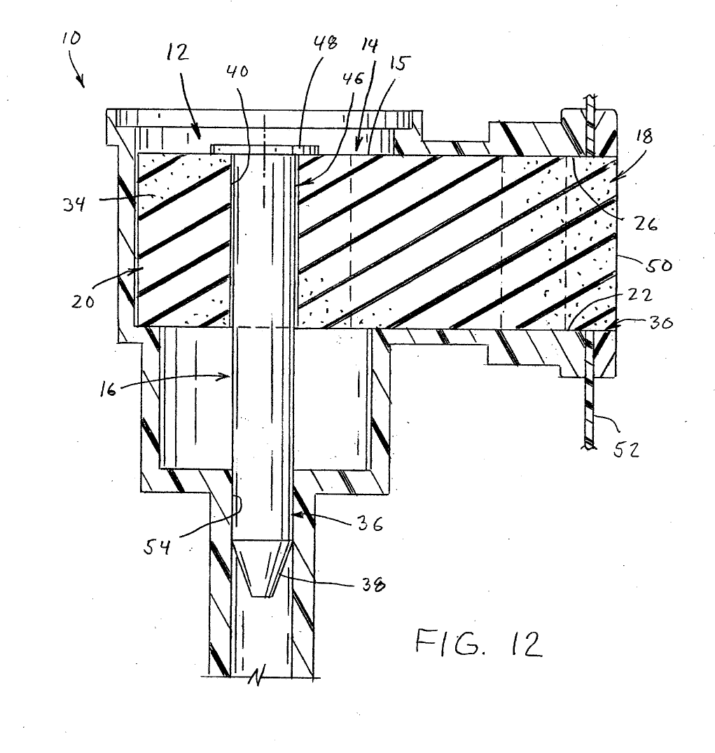

Turning now to the attached FIGS. 1-12, therein illustrated is a skimmer protector or plug assembly 12 embodying the present invention. The plug assembly can be placed or mounted in the passageway of the pool skimmer 10 which is typically positioned on a vertical wall 52 of an associated swimming pool. The plug assembly 12 can be installed when the pool is being winterized to prevent a detrimental amount of water from entering and occupying the skimmer 10 passageway through the mouth 30 of the skimmer 10.

When the plug assembly 12 is installed in the skimmer passageway 30, it resiliently presses against the entrance walls of the skimmer mouth 30 and into the wall openings 22, 24, 26, 28 and corners of the skimmer passageway 30. This results in a quickly and easily installed plug assembly 12 as compared with prior known skimmer covers which, typically are mounted (using a variety of hardware) on the outer surface of a face plate which extends about the skimmer opening 30. The plug 12, as described herein, can be used on skimmers 10 for both inground and aboveground pools, and can be used with skimmers 10 that do not include face plates.

The skimmer insert 14 as shown in FIGS. 1-4, includes a generally rectilinear face portion 50 (proximal to front section 18) which is dimensioned and configured to occupy the rectilinear opening 30 of the skimmer 10. Proximal to rear section 20, a rearwardly extending leg 34 of the skimmer insert 14 can be dimensioned to occupy a majority of the area around and above the skimmer throat opening.

A generally circular opening or aperture 40 extends through the rear leg or support portion 34 of the skimmer insert 14 proximal to the rear portion 20 of the insert 14. The aperture 40 is dimensioned to receive an anchoring pin 16 (FIGS. 5-7) which when inserted extends through the aperture 40. A lower portion 36 of the anchoring pin 16 mounts in a receiving opening 54 in the back of the skimmer throat. When installed, the anchoring pin's 16 lower portion 36 extends through the rear leg 34 of the insert 14 and into the opening 54 of the skimmer throat, thereby frictionally securing the skimmer insert 14 and anchoring pin 16 within the skimmer. The lower portion of the anchoring pin 16 includes a tapered generally circular end 38 for self-orienting and self-centering into the throat opening 54 of the skimmer 10. The anchoring pin 16 includes an upper portion 46 including a terminal collar 48. The collar 48 includes a diameter greater than a diameter of the anchoring pin portions 36, 46. The diameter of the collar 48 is greater than a diameter of the aperture 40 of the skimmer insert 14. It is to be appreciated that the skimmer insert 14, once seated into the pool skimmer 10, can receive the anchoring pin 16 from above. The anchoring pin 16 can then be placed, from above, into the aperture 40 of the insert 14. The pin 16 passes through the insert 14 rear leg 34 until the lower portion 36 and terminal tapered end 38 extend into the throat opening 54 of the skimmer 10. The collar 48 stops further movement of the pin 16 when the collar 48 engages the top surface 15 of the insert 14.

It is to be appreciated that the forward extending rectilinear portion 18 of the skimmer insert 14 occupies nearly all of the area of the skimmer mouth 30, thereby preventing an accumulation of water within the skimmer mouth 30.

The skimmer insert 14 and anchoring pin 16 can each be formed as single pieces, respectively, from a resiliently deformable synthetic resin that will retain its resiliency over a broad temperature range. The skimmer insert 14 and anchoring pin 16 can each be molded in one piece from a durable, relatively hard, synthetic resin, such as polyethylene, polypropylene, ABS, polyimides, and Styrofoam.

It is to be appreciated that the skimmer insert 14 can include a deformable material that can compress and deform should any residual water around the skimmer mouth 30, and in or around the skimmer throat 54, freeze and expand whereby such expansion will compress on the skimmer protector 12 inwardly. In this manner, any expansion from freezing water, and the resultant forces therefrom, will be absorbed by the skimmer protector 12 and not be directed outward on the walls 22, 24, 26, 28 of the skimmer mouth 30, skimmer throat 54, and/or sidewalls 52 of the pool.

In order to install the skimmer insert 14, the insert 14 is first positioned through the skimmer mouth 30 from an interior direction and is then pushed rearward into the skimmer mouth 30 until the front face 50 of the insert is generally seated within the skimmer mouth 30. The rearwardly extending leg 34 of the skimmer insert 14 is positioned adjacent the back of the skimmer throat. Once the insert 14 is seated in this orientation, the anchoring pin 16 can be inserted into the insert aperture 40, thereby securing the insert 14 and anchoring pin 16 within the pool skimmer 10. The skimmer throat can then be sealed with the securing of a cover (not shown) over the skimmer throat and plug assembly 12. The cover prevents water and rain from entering the skimmer throat.

Thus there has been shown and described a novel swimming pool skimmer protector which fulfills all the objectives and advantages sought therefor. Many changes, modifications, variations and other uses and applications of the subject invention will, however, become apparent to those skilled in the art after considering this specification together with the accompanying drawings and claims. All such changes, modifications, variations and other uses and applications which do not depart from the spirit and scope of the invention are deemed to be covered by the invention which is limited only by the claims which follow.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A winterizing protector for a pool skimmer having a housing with an opening thereinto and a passageway extending therethrough, said protector comprising:
a skimmer insert dimensioned and configured to block an opening and having a support portion dimensioned to extend through the opening and into the passageway to prevent water flow through the skimmer passageway;
means for anchoring said skimmer insert into the pool skimmer;
said anchoring means comprises an anchor pin passing through an aperture in a rear leg of said skimmer insert; and,
a lower portion of said anchor pin extends into a receiving opening in a throat of the pool skimmer.

2. The protector of claim 1, wherein said anchor pin is frictionally engaged to said skimmer insert and to said receiving opening in said throat of the pool skimmer.

3. The protector of claim 2, wherein an upper portion of said anchor pin coextensive with said aperture in said rear leg of said skimmer insert.

4. A winterizing protector for a pool skimmer, said protector comprising:
the pool skimmer including a housing with an opening therein and a passageway therethrough;
said housing defining a cavity including a volume therein;
a plug assembly dimensioned and configured to occupy a majority of the cavity of the housing;
said plug assembly including a skimmer insert and an anchoring pin; and,
in an assembled orientation, said anchoring pin includes a lower portion extending into a receiving opening in a throat of the pool skimmer, and an upper portion extending through an aperture in a rear portion of said skimmer insert.

5. The protector of claim 4, wherein said lower portion is frictionally engaged with said throat of the pool skimmer.

6. The protector of claim 5, wherein said upper portion of said anchor pin frictionally engaged with a surrounding wall of said aperture.

7. The protector of claim 6, wherein said upper portion of said anchor pin includes an upper flange having a diameter larger than a diameter of a body of said anchor pin; and,
wherein said upper flange engages a top surface of said skimmer insert for prohibiting further travel into said aperture of said rear portion of said skimmer insert.

8. A method for restricting water intake into a pool skimmer, the method comprising:
inserting a skimmer insert into a front opening of the pool skimmer;
wherein said skimmer insert includes a shape at least partially conforming to a cavity defined by a housing of the pool skimmer;
wherein said skimmer insert includes an aperture proximal to a rear portion of said skimmer insert; and,
inserting an anchoring pin into said aperture.

9. The method of claim 8, wherein said anchoring pin includes a lower portion extending into a receiving opening in a throat of the pool skimmer.

10. The method of claim 9, wherein said anchoring pin includes an upper portion coextensive with a wall defining said aperture of said skimmer insert.

11. The method of claim 10, wherein said upper portion of said anchor pin includes an upper flange having a diameter larger than a diameter of a body of said anchor pin; and,
wherein said upper flange engages a top surface of said skimmer insert for prohibiting further travel of said anchor pin into said aperture of said rear portion of said skimmer insert.
